(19) United States
(12) Patent Application Publication
(10) Pub. No.: US 2016/0103509 A1
(43) Pub. Date: Apr. 14, 2016

(54) TOUCH DISPLAY DEVICE

(71) Applicant: INNOLUX CORPORATION, Chu-Nan (TW)

(72) Inventor: Chung-Wen YEN, Chu-Nan (TW)

(21) Appl. No.: 14/574,198

(22) Filed: Dec. 17, 2014

(30) Foreign Application Priority Data
Oct. 9, 2014 (TW) 103135210

(51) Int. Cl. G06F 3/041

(52) U.S. Cl. CPC G06F 3/041

(57) ABSTRACT

A touch display device is disclosed, which comprises: a first substrate with a first surface having a central touch area and a periphery touch area, wherein the periphery touch area locates at one side of the central touch are; plural first sensing electrodes disposed on the central touch area and arranged along a first direction; plural periphery dummy electrode rows disposed on the periphery touch area and arranged along a second direction intersecting with the first direction, wherein the periphery dummy electrode rows comprise: a first periphery dummy electrode row and a second periphery dummy electrode row, and a length of the first periphery dummy electrode row in the second direction is smaller than that of the second periphery dummy electrode row.

### CROSS REFERENCE TO RELATED APPLICATION

This application claims the benefits of the Taiwan Patent Application Serial Number 103135210, filed on Oct. 9, 2014, the subject matter of which is incorporated herein by reference.

### BACKGROUND OF THE INVENTION

1. Field of the Invention

The present invention relates to a touch display device and, more particularly, to a touch display device with improved touch sensitivity and better circuit layout.

2. Description of Related Art

Recently, with the development trend of user-friendly operation and simplicity, touch display devices are becoming more and more widely used in the production and life. Since the user can input signals directly by hand or other objects to access the touch display device, the user's dependence on other input devices (such as a keyboard, a mouse, a remote controller and so on) are thus reduced or even eliminated, thereby greatly facilitating the user's operation.

Recently, there have been attempts to integrate the touch panel circuits on the glass substrate of the display panel to realize miniaturization and lightweight. However, the circuit formed on the glass substrate is typically made of a transparent conductive material, such as indium tin oxide (ITO) or indium zinc oxide (IZO), which has a refractive index difference from that of the transparent substrate. As a result, the circuit area and the non-circuit area on the glass substrate may be easily distinguished by naked eyes due to the difference in refractive indices, thus affecting the overall transparent appearance.

In view of the above problems, some touch display devices are equipped with dummy electrodes to reduce the visibility of the circuits. However, the disposition of the dummy electrodes may cause the touch sensitivity of the touch panel decreased. Therefore, it is desirable to provide a touch panel which can achieve the purpose of reducing the visibility of the circuits and enhancing the touch sensitivity thereof at the same time.

### SUMMARY OF THE INVENTION

The object of the present invention is to provide a touch display device, in which dummy electrode rows are designed to have different width or comprises different numbers of dummy electrodes, to improve the sensitivity of the touch panel or facilitate the layout design of the sensing electrodes.

To achieve the abject, a first aspect of the present invention is to provide a touch display device, comprising: a first substrate with a first surface having a central touch area and a periphery touch area, wherein the periphery touch area locates at one side of the central touch area; plural first sensing electrodes disposed on the central touch area and arranged along a first direction; and plural periphery dummy electrode rows disposed on the periphery touch area and arranged along a second direction intersecting with the first direction, wherein the periphery dummy electrode rows comprise: a first periphery dummy electrode row and a second periphery dummy electrode row, wherein a length of the first periphery dummy electrode row in the second direction is smaller than that of the second periphery dummy electrode row in the second direction.

In the first aspect of the present invention, the touch display device may further comprise: a terminal unit electrically connecting to the first sensing electrodes and adjacent to an edge of the first substrate, wherein the edge extends along the first direction, wherein the first periphery dummy electrode row locates between the edge and the second periphery dummy electrode row.

In the touch display device of the first aspect of the present invention, the first periphery dummy electrode row comprises plural first periphery dummy electrodes arranged along the first direction, and the second periphery dummy electrode row comprises plural second periphery dummy electrodes arranged along the first direction.

In the first aspect of the present invention, the touch display device may further comprise a first central dummy electrode row disposed on the central touch area, which comprises plural first central dummy electrodes arranged along the first direction, wherein a number of the first periphery dummy electrodes contained in the first periphery dummy electrode row is less than that of the first central dummy electrodes contained in the first central dummy electrode row.

In the touch display device of the first aspect of the present invention, one of the first sensing electrodes further has plural slits extending along the second direction.

In the touch display device of the first aspect of the present invention, a distance between two adjacent slits is substantially equal to a width of the first periphery dummy electrode or the second periphery dummy electrode.

In the touch display device of the first aspect of the present invention, the first sensing electrodes, the first periphery dummy electrodes and the second periphery dummy electrodes respectively have a zigzag edge.

In the first aspect of the present invention, the touch display device may further comprise: plural sub-pixels disposed on a second surface of the first substrate opposite to the first surface, wherein a length of the first periphery dummy electrode row or the second periphery dummy electrode row in the second direction is substantially equal to even-number times of a length of the sub-pixels in the second direction.

In the touch display device of the first aspect of the present invention, a part of the first periphery dummy electrode row is not overlapped with the sub-pixels.

In the touch display device of the first aspect of the present invention, two adjacent first periphery dummy electrodes respectively have a first width and a second width in the first direction, and the first width is larger than the second width.

In the first aspect of the present invention, the touch display device may further comprise: a second substrate opposite to the first substrate; and plural second sensing electrodes disposed on the second substrate and arranged along the second direction.

In addition, a second aspect of the present invention is to provide another touch display device, comprising: a first substrate with a first surface having a central touch area and a periphery touch area, wherein the periphery touch area locates at one side of the central touch area; plural first sensing electrodes disposed on the central touch area and arranged along a first direction; a connecting portion, wherein two adjacent first sensing electrodes electrically connect to each other through the connecting portion; and plural central dummy electrode rows disposed between two adjacent first sensing electrodes and arranged along a second direction intersecting the first direction, wherein the central dummy electrode rows comprises: a first central dummy electrode row and a second central dummy electrode row, and the first central dummy electrode row locates between the connecting portion and the second central dummy electrode row, wherein a length of the first central dummy electrode row in the second direction is smaller than that of the second central dummy electrode row in the second direction.

In the touch display device of the second aspect of the present invention, the first central dummy electrode row comprises plural first central dummy electrodes arranged along the first direction, and the second central dummy electrode row comprises plural second central dummy electrodes arranged along the first direction.

In the second aspect of the present invention, the touch display device may further comprise: a first periphery dummy electrode row disposed on the periphery touch area and comprising plural first periphery dummy electrodes arranged along the first direction, wherein a number of the first periphery dummy electrodes contained in the first periphery dummy electrode row is less than that of the first central dummy electrodes contained in the first central dummy electrode row.

In the touch display device of the second aspect of the present invention, each first sensing electrode respectively has plural slits extending along the second direction.

In the touch panel of the second aspect of the present invention, a distance between two adjacent slits is substantially equal to a width of the first central dummy electrode or the second central dummy electrode.

In the touch display device of the second aspect of the present invention, the first sensing electrodes, the first central dummy electrodes and the second central dummy electrodes respectively have a zigzag edge.

In the second aspect of the present invention, the touch display device may further comprise: plural sub-pixels disposed on a second surface of the first substrate opposite to the first surface, wherein a length of the first central dummy electrode row or the second central dummy electrode row in the second direction is substantially equal to even-number times of a length of the sub-pixels in the second direction.

In the touch display device of the second aspect of the present invention, a part of the first central dummy electrode row is not overlapped with the sub-pixels.

In the touch display device of the second aspect of the present invention, two adjacent first central dummy electrodes respectively have a first width and a second width in the first direction, and the first width is larger than the second width.

In the second aspect of the present invention, the touch display device may further comprise: a second substrate opposite to the first substrate; and plural second sensing electrodes disposed on the second substrate and arranged along the second direction.

In the touch display device provided in the present invention, the length of the first periphery dummy electrode in the second direction is designed to be smaller than that of the second periphery dummy electrode in the second direction, wherein the first periphery dummy electrode is arranged near to the edge of the first substrate or the connecting portion for the first sensing electrodes, and thus the sensitivity of the touch display device can be improved. Furthermore, in the touch display device provided in the present invention, a number of the first periphery dummy electrodes contained in the first periphery dummy electrode row on the periphery touch area is designed to be less than that of the first central dummy electrodes contained in the first central dummy electrode row on the central touch area, and thus the sensitivity of the touch display device can further be improved.

Other objects, advantages, and novel features of the invention will become more apparent from the following detailed description when taken in conjunction with the accompanying drawings.

### BRIEF DESCRIPTION OF THE DRAWINGS

FIG. 1A is an exploded view of a touch display device according to Embodiment 1 of the present invention;

FIG. 1B is a cross-sectional view of a touch display device according to Embodiment 1 of the present invention;

FIG. 2 is a schematic view showing first sensing electrodes in a touch display device according to Embodiment 1 of the present invention;

FIG. 3A is a schematic view showing a part of first sensing electrodes and dummy electrodes according to Embodiment 1 of the present invention;

FIG. 3B is an enlarge view of a part of FIG. 3A;

FIG. 4A is a schematic view showing a part of first sensing electrodes and dummy electrodes on a first surface and sub-pixels on a second surface in a touch display device according to Embodiment 1 of the present invention;

FIG. 4B is an enlarge view of a part of FIG. 4A;

FIG. 5 is a schematic view showing a part of first sensing electrodes and dummy electrodes according to Embodiment 2 of the present invention;

FIG. 6 is a schematic view showing a part of first sensing electrodes and dummy electrodes according to Embodiment 3 of the present invention;

FIG. 7A is a schematic view showing a part of first sensing electrodes and dummy electrodes according to Embodiment 4 of the present invention; and

FIG. 7B is an enlarge view of a part of FIG. 7A.

### DETAILED DESCRIPTION OF THE PREFERRED EMBODIMENT

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

### Embodiment 1

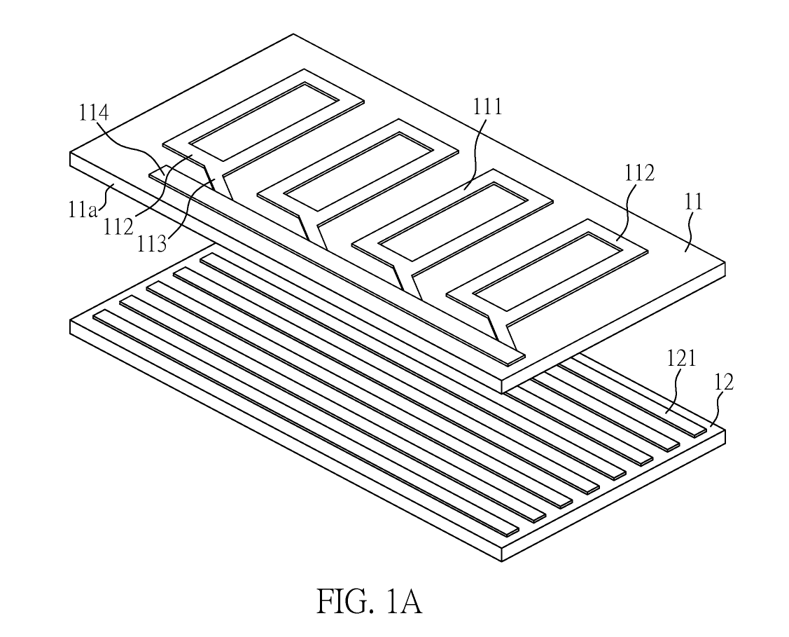

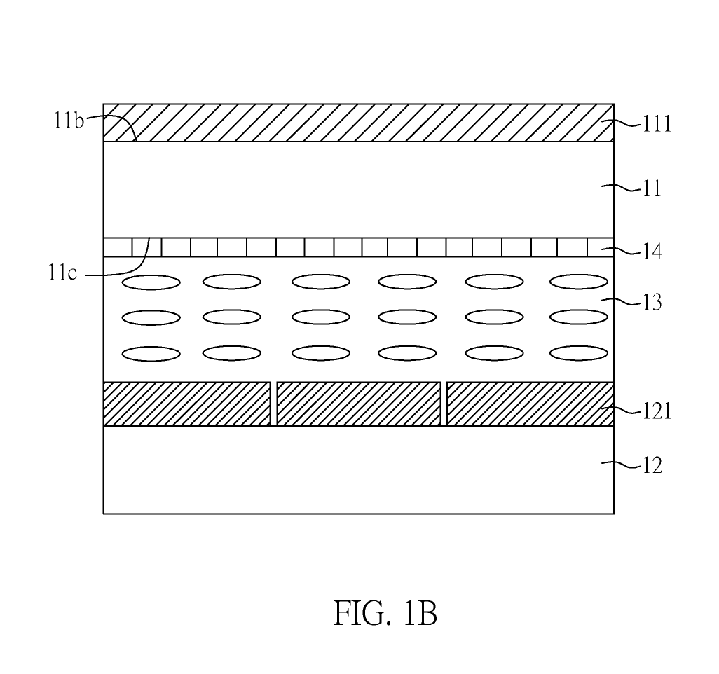

As shown in FIGS. 1A and 1B, the touch display device of the present embodiment comprises: a first substrate 11 having at least one edge 11a; and plural first sensing electrodes 111 disposed on the first substrate 11 and arranged along a first direction. In addition, the touch display device of the present embodiment further comprises: a second substrate 12 opposite to the first substrate 11; and plural second sensing electrodes 121 disposed on the second substrate 12 and arranged along the second direction. In the present embodiment, the first sensing electrodes 111 and the second sensing electrodes 121 are used as touch electrodes. In addition, the first direction intersects the second direction and, particularly the first direction is substantially vertical to the second direction. Herein, the term “substantially vertical” indicates that an included angle between the first direction and the second direction is in a range between 85° and 90°.

As shown in FIG. 1B, the touch display device of the present embodiment is a touch panel integrated with a display panel, wherein a liquid crystal layer 13 is disposed between the first substrate 11 and the second substrate. The first substrate 11 has a first surface 11b and a second surface 11c opposite to the first surface 11b, wherein the first sensing electrodes 111 are disposed on the first surface 11b, and a color filter layer 14 comprising plural sub-pixels is further disposed on the second surface 11c of the first substrate 11. In the present embodiment, a LCD touch display device is exemplified, but the present invention is not limited thereto. In other embodiments of the present invention, the touch panel of the present embodiment may be integrated with other known display panel used in the art, for example, a touch panel integrated with an OLED display panel.

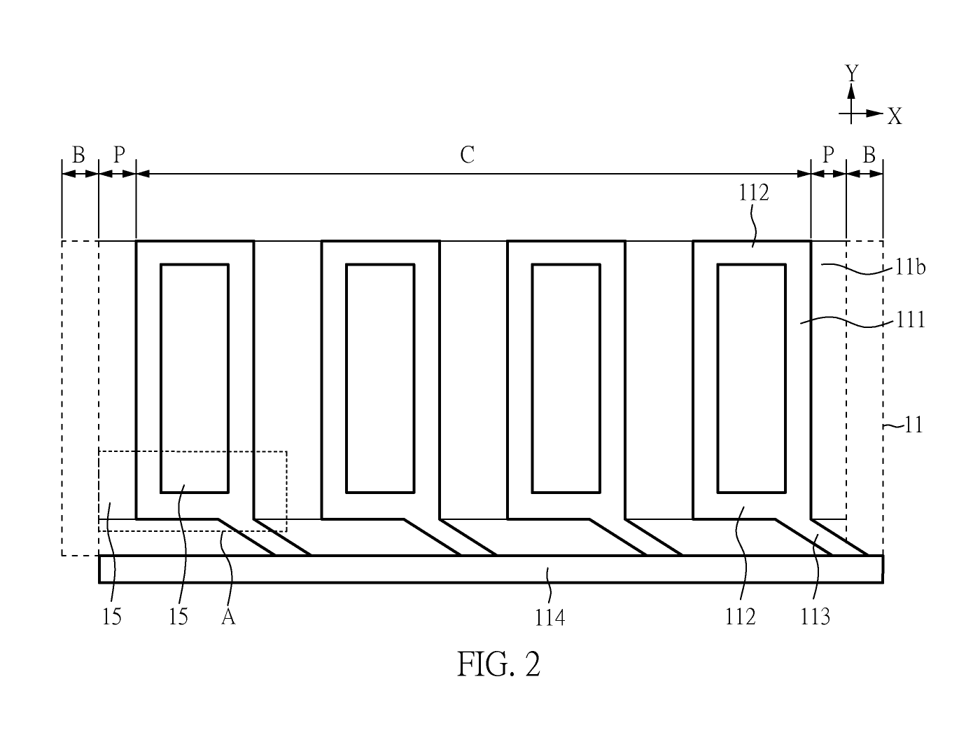

Hereinafter, the structures of the first sensing electrodes and units adjacent thereto on the first substrate in the touch panel of the present embodiment are illustrated below. As shown in FIG. 2, in the touch panel of the present embodiment, plural first sensing electrodes 111 are disposed on the first substrate 11 and arranged along a first direction X. In addition, the first surface 11b of the first substrate 11 has a central touch area C and periphery touch areas P locating at two sides of the central touch area C, as well as two border regions B locating outside the periphery touch areas P, wherein the first sensing electrodes 111 are disposed on the central touch area C. Herein, on the central touch area C and the periphery touch areas P of the first substrate 11, the region outside the first sensing electrodes 111 is a dummy electrode region 15 disposed with dummy electrodes (not shown in the figure). The disposition of the dummy electrodes (not shown in the figure) can improve the problem that the user may observe the pattern of the first sensing electrodes 111 during the operation of the touch panel, and thus the visibility of the pattern of the first sensing electrodes 111 can be reduced. Herein, the first sensing electrodes 111 and the dummy electrodes (not shown in the figure) are made of any material for touch electrodes generally used in the art, for example, transparent conductive oxides such as ITO and IZO. In addition, the first sensing electrodes 111 and the dummy electrodes (not shown in the figure) can be manufactured by depositing a transparent conductive oxide layer, followed by a patterning process (such as etching process) to define the same.

Furthermore, as shown in FIGS. 1A and 2, in the touch panel of the present embodiment, two adjacent first sensing electrodes 111 electrically connect to each other through the two connecting portions 112 and preferably, these two connecting portions 112 are substantially parallel to the edge 11a of the first substrate 11. In addition, the touch panel of the present embodiment further comprises an extension portion 113 connecting to one of these two connecting portions 112, wherein the extension portion 113 electrically connects to a terminal unit 114 so that the terminal unit 114 can be electrically connect to the first sensing electrodes 111. Herein, two connecting portions 112 and the extension portion 113 are integrated with the first sensing electrodes 111. The terminal unit 114 is adjacent to an edge of the first substrate 11 extending along the first direction X. As shown in FIG. 2, the extension portions 113 beveled-extend to electrically connect with the terminal unit 114. Herein, the term “beveled-extend” indicates a direction other than the first direction X and the second direction Y, i.e. another direction intersecting both the first direction X and the second direction Y.

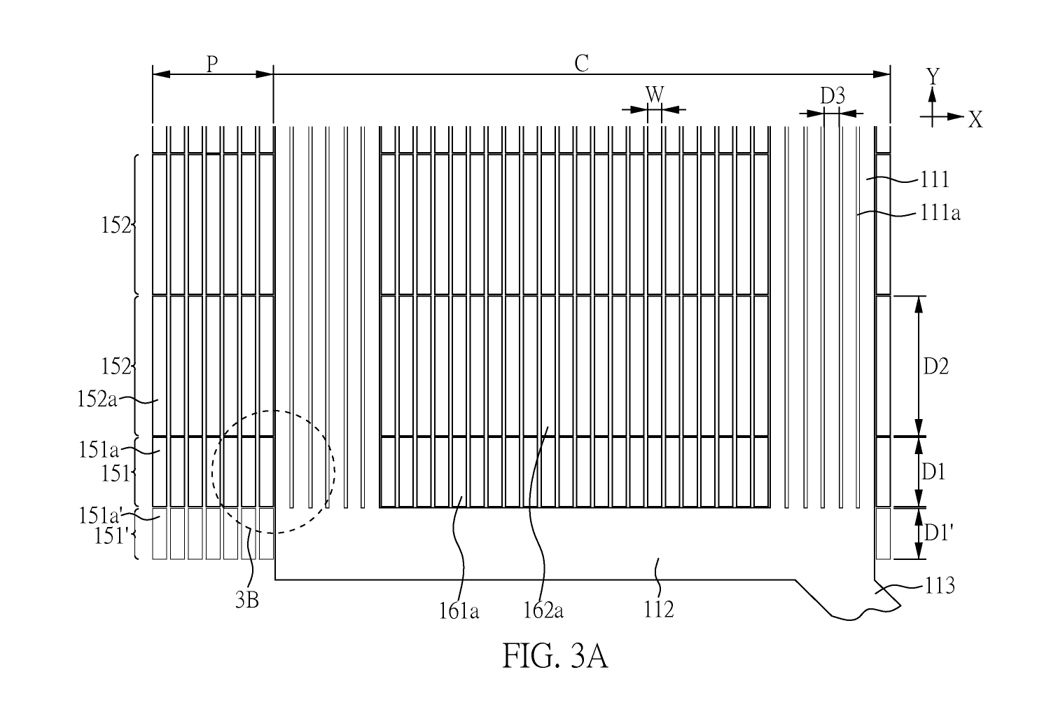

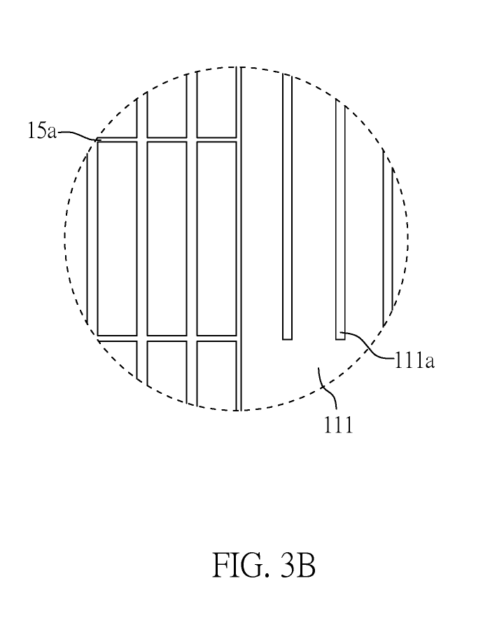

Hereinafter, the structures of a part of the first sensing electrodes and the dummy electrodes in the dummy electrode region on the first substrate in the touch panel of the present embodiment are illustrated below. As shown in FIG. 3A, which is an enlarge view showing the region A indicated in FIG. 2, the touch panel of the present embodiment comprises: plural periphery dummy electrode rows in the dummy electrode regions and on the periphery touch areas P, which are arranged along the second direction Y. Herein, the periphery dummy electrode rows comprise: at least one first periphery dummy electrode row 151, 151′ comprising plural first periphery dummy electrodes 151a, 151a′ arranged along the first direction X; and a second periphery dummy electrode row 152 comprising plural second periphery dummy electrodes 152a arranged along the first direction X, wherein the first periphery dummy electrode rows 151, 151′ locate between the edge 11a (as shown in FIG. 1A) of the first substrate 11 and the second periphery dummy electrode row 152. In the present embodiment, the first periphery dummy electrode rows 151, 151′ and the second periphery dummy electrode row 152 are arranged along the second direction Y. Furthermore, the first periphery dummy electrodes 151a, 151a′ of the first periphery dummy electrode rows 151, 151′, the second periphery dummy electrodes 152a of the second periphery dummy electrode row 152, and the first sensing electrodes 111 are electrically insulated with each other by slits 15a defined through an etching process, as shown in FIG. 3B. In addition, the first direction X intersects the second direction Y and, particularly the first direction X is substantially vertical to the second direction Y. Moreover, the lengths D1, D1′ of the first periphery dummy electrodes 151a, 151a′ of the first periphery dummy electrode rows 151, 151′ in the second direction Y is smaller than the length D2 of the second periphery dummy electrodes 152a of the second periphery dummy electrode row 152 in the second direction Y. Meanwhile, in the periphery touch area P, from the edge 11a of the first substrate 11 (as shown in FIG. 1A), the lengths D1′, D1 of the first periphery dummy electrodes 151a′, 151a in the second direction Y are gradually increased. Especially, the first periphery dummy electrodes 151a′ of the first periphery dummy electrode row 151′ near to the connecting portion 112 have the minimum lengths D1′ in the second direction Y.

In the present embodiment, the lengths D1, D1′ of the first periphery dummy electrodes 151a, 151a′ in the second direction Y is designed to be smaller than the length D2 of the second periphery dummy electrodes 152a in the second direction Y, and thus the sensitivity of the touch panel can further be increased. In addition, in order to achieve the purpose that the touch panel have dummy electrodes disposed on entire surface of the first substrate to prevent the problem that the user might observe the pattern of the first sensing electrodes 111, the first periphery dummy electrodes 151a′ of the first periphery dummy electrode row 151′ near to the connecting portion 112 are designed to have the minimum lengths D1′ to facilitate the electrically connection between the beveled-extend extension portion 113 and the terminal unit (not shown in the figure).

As shown in FIG. 3A, in the touch panel of the present embodiment, plural central dummy electrode rows are disposed on the central touch area C, which comprises: a first central dummy electrode row comprising plural first central dummy electrodes 161a arranged along the first direction X; and a second central dummy electrode row comprising plural second central dummy electrodes 162a arranged along the first direction X. Herein, the first central dummy electrode row comprising plural first central dummy electrodes 161a and the second central dummy electrode row comprising plural second central dummy electrodes 162a are disposed between two adjacent first sensing electrodes 111 and arranged along a second direction Y, and the first central dummy electrode row comprising plural first central dummy electrodes 161a locates between the connecting portion 112 and the second central dummy electrode row comprising plural second central dummy electrodes 162a. In addition, the length D1 of the first central dummy electrode row comprising the first central dummy electrodes 161a in the second direction Y is smaller than the length D2 of the second central dummy electrode row comprising the second central dummy electrodes 162a in the second direction Y.

Furthermore, as shown in FIG. 3A, in the embodiment of the present invention, a width of the periphery touch areas P is smaller than that of the central touch area C. Hence, the number of the second periphery dummy electrodes 152a in each second periphery dummy electrode row 152 on the periphery touch area P is less than that of the second central dummy electrodes 162a in each second central dummy electrode row on the central touch area C. Meanwhile, the number of the first periphery dummy electrodes 151a, 151a′ contained in each one of the first periphery dummy electrode rows 151, 151′ on the periphery touch area P is less than that of the first central dummy electrodes 161a contained in the first central dummy electrode row on the central touch area C. Since the main touch region in the touch panel of the present embodiment is the central touch area C disposed with first sensing electrodes 111, the size of the periphery touch area P outside the central touch area C have to be minimized to improve the touch sensitivity of the touch panel. Hence, in the touch panel of the present embodiment, a number of the periphery dummy electrodes contained in the periphery dummy electrode row located on the periphery touch area P is designed to be less than that of the central dummy electrodes contained in the central dummy electrode row located on the central touch area C; and thus the width of the periphery touch areas P can be smaller than that of the central touch area C to achieve the purpose of improving the touch sensitivity of the touch panel.

In addition, as shown in FIG. 3A, in the touch panel of the present embodiment, each first sensing electrode 111 further has plural slits 111a extending along the second direction Y. Herein, a distance D3 between two adjacent slits 111a is substantially equal to a width W of the first periphery dummy electrode 151a, 151a′ or the second periphery dummy electrode 152a. Herein, the term “substantially equal” refers to that a variation between the distance between two adjacent slits and the width of the first periphery dummy electrode or the second periphery dummy electrode is in a range from 0% to 10%.

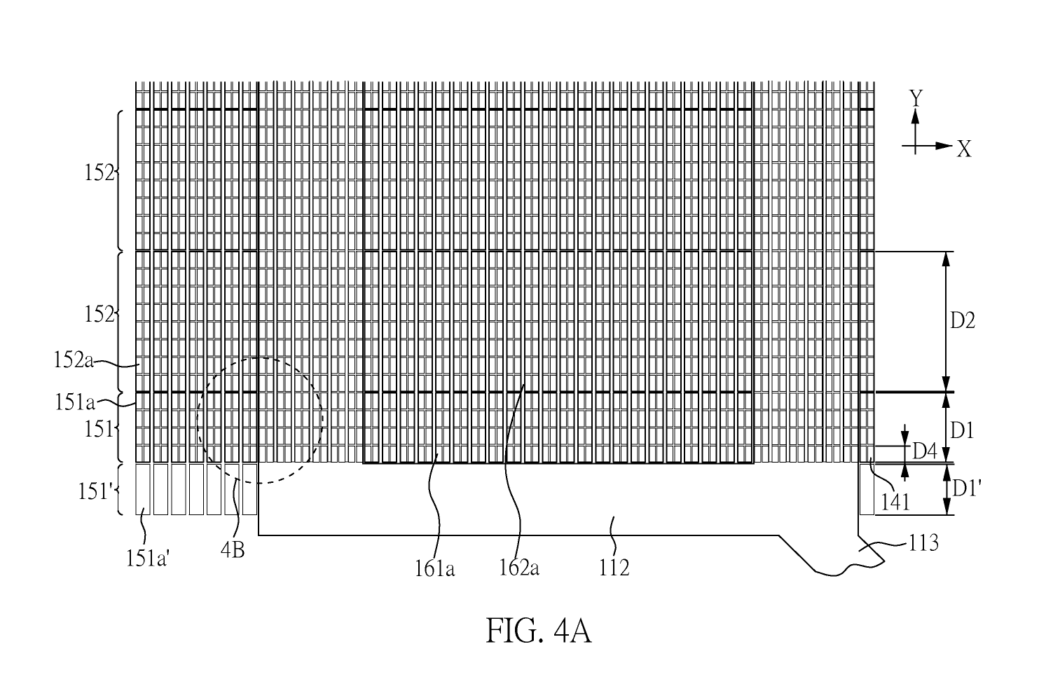

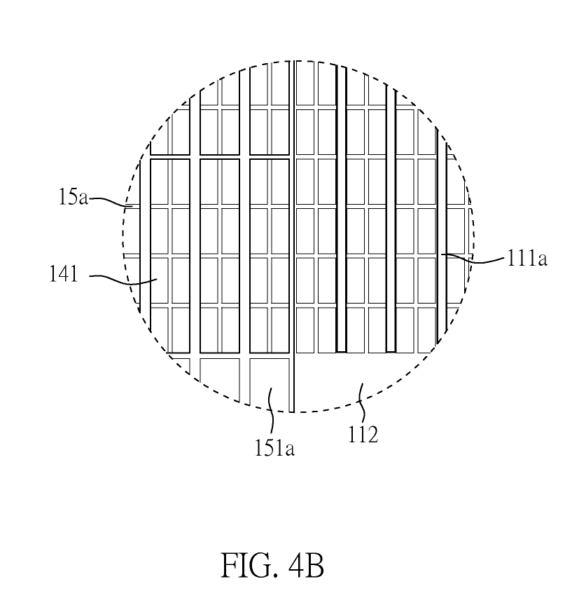

In the touch panel of the present embodiment, the first substrate 11 and the second substrate 12 can be common substrates used in the art, such as glass substrates and plastic substrates. In addition, as shown in FIG. 1B, the touch panel of the present embodiment is a touch panel display integrated with a LCD panel, so a color filter layer 14 comprising plural sub-pixels 141 is further disposed on an side of the first substrate 11 opposite to the side with first sensing electrodes 111 disposed thereon, as shown in FIGS. 4A and 4B, which is a schematic view showing the touch region on the first surface 11b of the touch panel overlapping with the color filter layer 14 on the second surface 11c. Herein, a length D1 of the first periphery dummy electrode row 151 or a length D2 of the second periphery dummy electrode row 152 in the second direction Y is substantially equal to even-number times of a length D4 of the sub-pixels 141 in the second direction Y. For example, in the present embodiment, the length D1 of the first periphery dummy electrode row 151 in the second direction Y is four times of the length D4 of the sub-pixels 141 in the second direction Y; and the length D2 of the second periphery dummy electrode row 152 in the second direction Y is eight times of the length D4 of the sub-pixels 141 in the second direction Y. Furthermore, as shown in FIG. 4A, in the present embodiment, the first periphery dummy electrode row 151′ is not overlapped with the sub-pixels 141.

### Embodiment 2

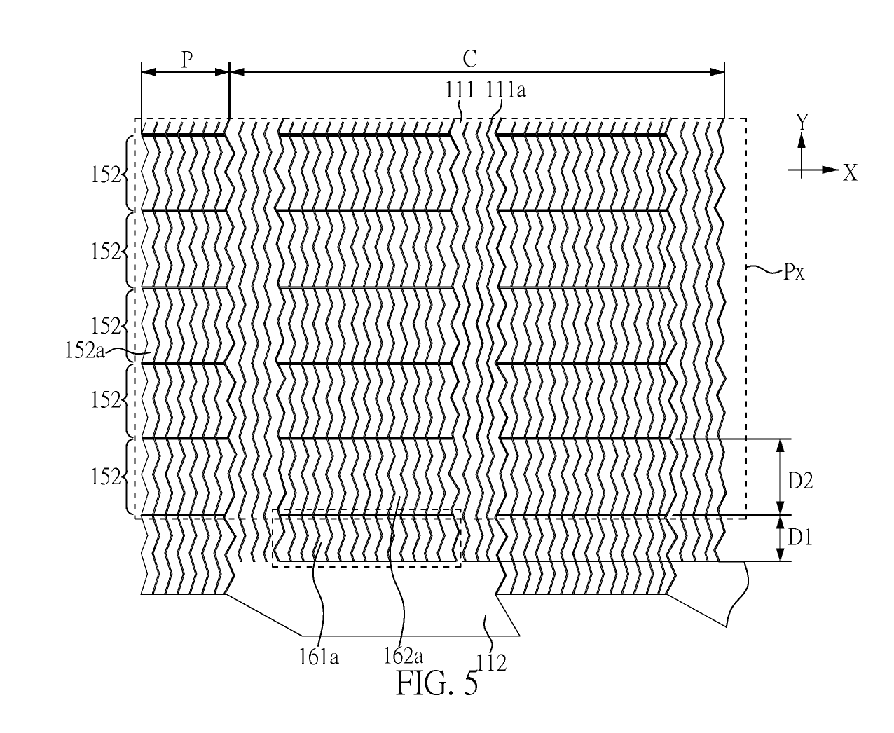

The structure of the touch panel in the present embodiment is similar to that illustrated in Embodiment 1, except the following differences. First, as shown in FIG. 5, the first sensing electrodes 111, the second periphery dummy electrodes 152a, the first central dummy electrodes 161a and the second central dummy electrodes 162a in the present embodiment respectively have a zigzag edge. Even though the second periphery dummy electrodes 152a, the first central dummy electrodes 161a and the second central dummy electrodes 162a in the present embodiment respectively have a zigzag edge, the length D1 of the first central dummy electrodes 161a refers to the minimum distance between the upper edge and the bottom edge thereof in the second direction Y as well as the lengths D2 of the second periphery dummy electrodes 152a and the second central dummy electrodes 162a refer to the minimum distances between the upper edges and the bottom edges thereof in the second direction Y.

In addition, in the touch panel of the present embodiment, the first periphery dummy electrode row in Embodiment 1 is not disposed on the periphery touch area P.

Herein, the touch panel of the present embodiment also is a touch panel display integrated with a LCD panel, wherein a part of the second periphery dummy electrode row 152 is not overlapped with the pixel region Px indicated by dot lines.

### Embodiment 3

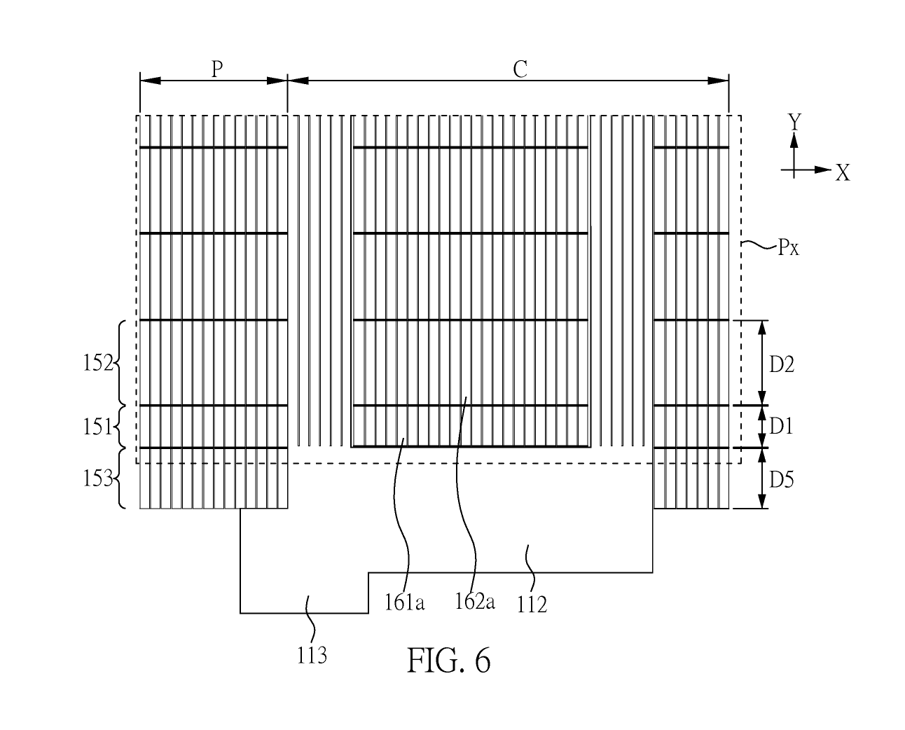

The structure of the touch panel in the present embodiment is similar to that illustrated in Embodiment 1, except the following differences. First, as shown in FIG. 6, in the touch panel of the present embodiment, the extension portions 113 does not beveled-extend but extends along the second direction Y. Hence, in order to achieve the purpose of disposing maximum number of dummy electrodes, the touch panel of the present embodiment may further comprise a third periphery dummy electrode row 153. The length D5 of the third periphery dummy electrode row 153 is not particularly limited, and can be determined by the extending direction of the extension portions 113. Preferably, the length D5 of the third periphery dummy electrode row 153 in the second direction Y is smaller than the length D2 of the second periphery dummy electrode row 152 in the second direction Y.

### Embodiment 4

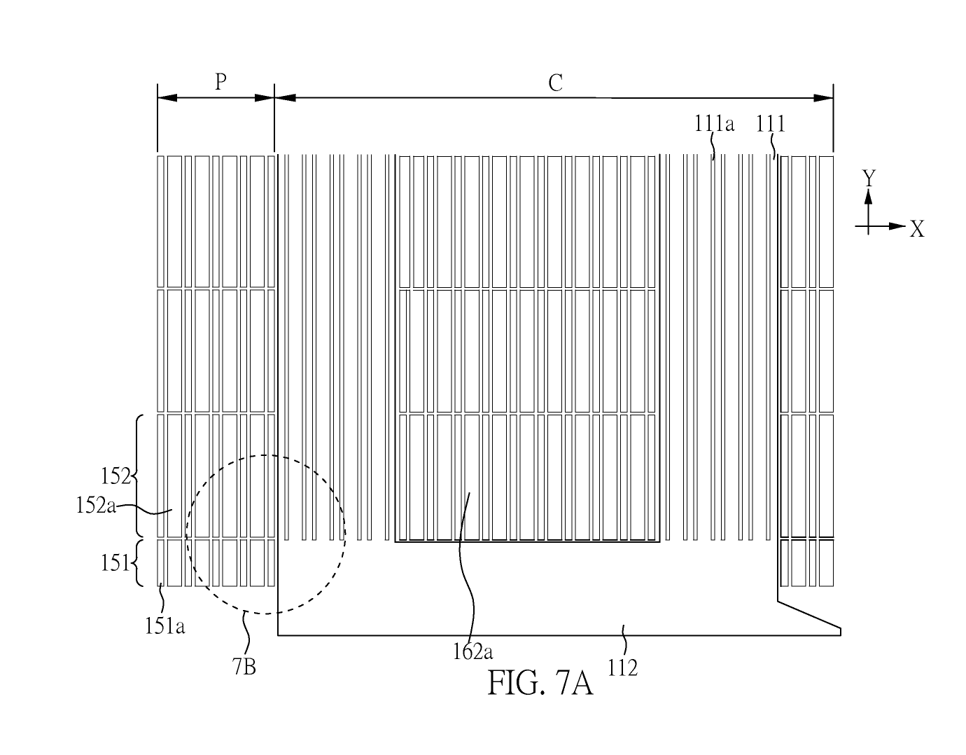

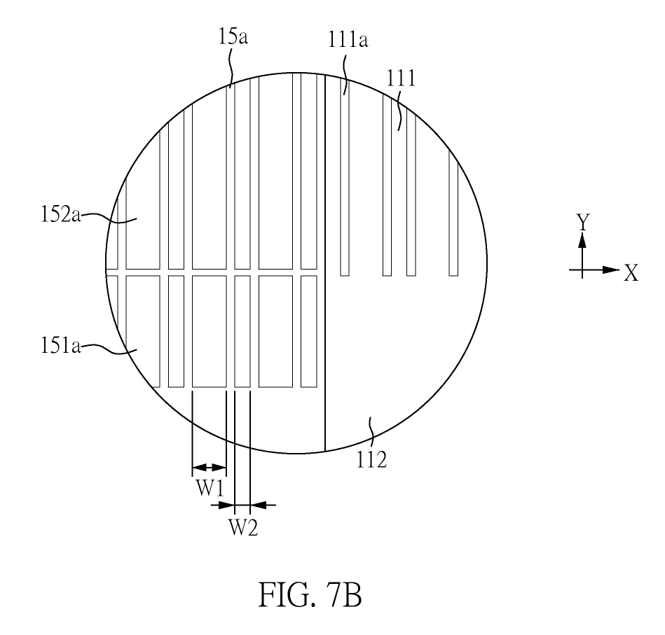

The structure of the touch panel in the present embodiment is similar to that illustrated in Embodiment 1, except the following differences. First, as shown in FIGS. 7A and 7B, two adjacent first periphery dummy electrodes 151a or two adjacent second periphery dummy electrodes 152a respectively have a first width w1 and a second width w2 in the first direction X, and the first width w1 is larger than the second width w2. In other words, plural slits 15a extending along the second direction Y are disposed between first periphery dummy electrodes 151a of the first periphery dummy electrode row 151 or between the second periphery dummy electrodes 152a of the second periphery dummy electrode row 152, and these slits 15a are alternately arranged in a first distance (which is almost equal to the distance indicated by the first width w1) and a second distance (which is almost equal to the distance indicated by the second width w2) along the first direction X. Preferably, in each first periphery dummy electrode row 151, the first periphery dummy electrodes 151a with the first width w1 and the first periphery dummy electrodes 151a with the second width w2 are alternatively arranged; and in each second periphery dummy electrode row 152, the second periphery dummy electrodes 152a with the first width w1 and the second periphery dummy electrodes 152a with the second width w2 are also alternatively arranged.

In addition, in the touch panel of the present embodiment, the first central dummy electrode row in Embodiment 1 is not disposed between the connecting portions 112 and the second central dummy electrode row comprising second central dummy electrodes 162a.

The touch panel provided by the aforementioned embodiments can be applied to any electronic devices required to have touch sensing function, and especially the touch display device, such as mobile phone, a notebook, a camera, a video camera, a music player, a navigation system, or a television.

Although the present invention has been explained in relation to its preferred embodiment, it is to be understood that many other possible modifications and variations can be made without departing from the spirit and scope of the invention as hereinafter claimed.

What is claimed is:

1. A touch display device, comprising:
a first substrate with a first surface having a central touch area and a periphery touch area, wherein the periphery touch area locates at one side of the central touch area;
plural first sensing electrodes disposed on the central touch area and arranged along a first direction; and
plural periphery dummy electrode rows disposed on the periphery touch area and arranged along a second direction intersecting with the first direction, wherein the periphery dummy electrode rows comprise: a first periphery dummy electrode row and a second periphery dummy electrode row,
wherein a length of the first periphery dummy electrode row in the second direction is smaller than that of the second periphery dummy electrode row in the second direction.

2. The touch display device as claimed in claim 1, further comprising:
a terminal unit electrically connecting to the first sensing electrodes and adjacent to an edge of the first substrate, wherein the edge extends along the first direction,
wherein the first periphery dummy electrode row locates between the edge and the second periphery dummy electrode row.

3. The touch display device as claimed in claim 1, wherein the first periphery dummy electrode row comprises plural first periphery dummy electrodes arranged along the first direction, and the second periphery dummy electrode row comprises plural second periphery dummy electrodes arranged along the first direction.

4. The touch display device as claimed in claim 3, further comprising a first central dummy electrode row disposed on the central touch area, which comprises plural first central dummy electrodes arranged along the first direction,
wherein a number of the first periphery dummy electrodes contained in the first periphery dummy electrode row is less than that of the first central dummy electrodes contained in the first central dummy electrode row.

5. The touch display device as claimed in claim 3, wherein one of the first sensing electrodes further has plural slits extending along the second direction.

6. The touch display device as claimed in claim 5, wherein a distance between two adjacent slits is substantially equal to a width of the first periphery dummy electrode or the second periphery dummy electrode.

7. The touch display device as claimed in claim 3, wherein the first sensing electrodes, the first periphery dummy electrodes and the second periphery dummy electrodes respectively have a zigzag edge.

8. The touch display device as claimed in claim 1, further comprising:
plural sub-pixels disposed on a second surface of the first substrate opposite to the first surface,
wherein a length of the first periphery dummy electrode row or the second periphery dummy electrode row in the second direction is substantially equal to even-number times of a length of the sub-pixels in the second direction.

9. The touch display device as claimed in claim 8, wherein a part of the first periphery dummy electrode row is not overlapped with the sub-pixels.

10. The touch display device as claimed in claim 3, wherein two adjacent first periphery dummy electrodes respectively have a first width and a second width in the first direction, and the first width is larger than the second width.

11. The touch display device as claimed in claim 1, further comprising:
a second substrate opposite to the first substrate;
a liquid crystal layer disposed between the first substrate and the second substrate;
plural second sensing electrodes disposed on the second substrate and arranged along the second direction.

12. A touch display device, comprising:
a first substrate with a first surface having a central touch area and a periphery touch area, wherein the periphery touch area locates at one side of the central touch area;
plural first sensing electrodes disposed on the central touch area and arranged along a first direction;
a connecting portion, wherein two adjacent first sensing electrodes electrically connect to each other through the connecting portion; and
plural central dummy electrode rows disposed between two adjacent first sensing electrodes and arranged along a second direction intersecting the first direction, wherein the central dummy electrode rows comprises: a first central dummy electrode row and a second central dummy electrode row, and the first central dummy electrode row locates between the connecting portion and the second central dummy electrode row,
wherein a length of the first central dummy electrode row in the second direction is smaller than that of the second central dummy electrode row in the second direction.

13. The touch display device as claimed in claim 12, wherein the first central dummy electrode row comprises plural first central dummy electrodes arranged along the first direction, and the second central dummy electrode row comprises plural second central dummy electrodes arranged along the first direction.

14. The touch display device as claimed in claim 13, further comprising a first periphery dummy electrode row disposed on the periphery touch area and comprising plural first periphery dummy electrodes arranged along the first direction,
wherein a number of the first periphery dummy electrodes contained in the first periphery dummy electrode row is less than that of the first central dummy electrodes contained in the first central dummy electrode row.

15. The touch display device as claimed in claim 13, wherein each first sensing electrode respectively has plural slits extending along the second direction.

16. The touch display device as claimed in claim 15, wherein a distance between two adjacent slits is substantially equal to a width of the first central dummy electrode or the second central dummy electrode.

17. The touch display device as claimed in claim 13, wherein the first sensing electrodes, the first central dummy electrodes and the second central dummy electrodes respectively have a zigzag edge.

18. The touch display device as claimed in claim 12, further comprising:
plural sub-pixels disposed on a second surface of the first substrate opposite to the first surface,
wherein a length of the first central dummy electrode row or the second central dummy electrode row in the second direction is substantially equal to even-number times of a length of the sub-pixels in the second direction.

19. The touch display device as claimed in claim 13, wherein two adjacent first central dummy electrodes respectively have a first width and a second width in the first direction, and the first width is larger than the second width.

20. The touch display device as claimed in claim 12, further comprising:
a second substrate opposite to the first substrate; and
a liquid crystal layer disposed between the first substrate and the second substrate;
plural second sensing electrodes disposed on the second substrate and arranged along the second direction.
